(19) United States
(12) Patent Application Publication
(10) Pub. No.: US 2013/0236337 A1
(43) Pub. Date: Sep. 12, 2013

(54) SOLENOID ACTUATORS USING EMBEDDED PRINTED CIRCUIT COILS

(71) Applicants: Mark A. Gummin, St. Helena, CA (US); Howard Cohen, Berkeley, CA (US); William Donakowski, El Sobrante, CA (US)

(72) Inventors: Mark A. Gummin, St. Helena, CA (US); Howard Cohen, Berkeley, CA (US); William Donakowski, El Sobrante, CA (US)

(21) Appl. No.: 13/775,149

(22) Filed: Feb. 23, 2013

Related U.S. Application Data
(60) Provisional application No. 61/685,003, filed on Mar. 9, 2012.
(60) Provisional application No. 61/686,305, filed on Apr. 3, 2012.

(51) Int. Cl. H02K 41/02; F04B 43/00; H02K 33/02

(52) U.S. Cl. CPC H02K 41/02; H02K 33/02; F04B 43/00
USPC 417/412; 310/14; 310/15

(57) ABSTRACT

A magnetomotive device has an embedded electromagnetic coil formed of multiple printed conductor segments on multiple lamina of a multilayer PCB. A shaft extends through an opening in the PCB, and a permanent magnet with axially opposed poles is secured to the shaft. Energizing the embedded electromagnet generates a magnetic field that attracts or repels the permanent magnet, driving the shaft to do useful work. A pair of embedded PCB coils may be employed, the shaft extending through both coils with the permanent magnet disposed therebetween, and the coils energized so that one repels the permanent magnet while the other attracts it, and the shaft may be driven reversibly to do useful work.

### CROSS-REFERENCE TO RELATED APPLICATIONS

This application claims filing date priority based on Provisional Applications No. 61/685,003, filed Mar. 9, 2012, and No. 61/686,305, filed Apr. 3, 2012.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to linear electromagnetic motors and, more particularly, to solenoid actuators used for driving switches, valves, pumps, and similar loads.

2. Description of Related Art

Traditional motors and solenoids use loops of insulated copper magnet-wire wound (or ‘turned’) around a bobbin or similar hollow structure to create a magnetic field that provides motive force to a moving core of ferromagnetic material when the coil is energized. Bobbins of magnet wire have been in wide use since the publication of Michael Faraday's research in 1831 and are used for motors, solenoids, and countless other applications. Now available in massive quantities as commodities from low-cost suppliers, wire-wound coils provide the backbone of the electromagnetic actuation industry.

But wound wire coils are not without their drawbacks and limitations. Their form factor defines the shape and scale of the device (much like a spool of thread), requiring hand assembly operations at several points in the manufacturing process. Mechanical & electrical (solder) connections must be made to the delicate, hair-thin wires, and mounting features and magnetic-circuit-confining iron components are built up around the bobbin. The mass of magnet wire, together with the mass of the ferromagnetic core, determines that solenoids have a large mass relative to the force that is developed and the stroke that is provided.

From an operational standpoint, motors and solenoids are prone to failure due to thermal cycling or mechanical stress on the fragile connections within the coil. Tiny copper wires, thermal cycling, heavy iron assemblies, and hand-assembly processes eventually lead to failure of the device at the weakest points.

Although solenoid construction has not changed significantly since Faraday, electronic circuit technology has progressed rapidly, particularly in the late 20^{th} and early 21^{st} century. Printed circuit techniques have enabled the creation of complex circuit connections using printed lines on a robust circuit board, resulting in radically reduced costs for constructing electronic circuits. Indeed, these printed circuit techniques have been used to form printed coils that are embedded in a multilayer circuit board. For example, U.S. Pat. No. 6,664,883 describes a printed circuit board (hereinafter, PCB) that has multiple layers, each layer hosting at least one printed conductor in the form of a loop or multiple loop. The loops are electromagnetically interactive, so that they may be used as an inductance or a voltage transformer in a circuit.

It is significant to note that this printed coil approach has not been applied to solenoid actuator design. Thus none of the benefits of modern PCB techniques and their economies of scale have been directed to ameliorate the drawbacks of traditional solenoid actuator designs.

### BRIEF SUMMARY OF THE INVENTION

The present invention generally comprises a method and apparatus that applies modern PCB techniques to the construction of solenoid actuators and similar electromagnetic motor devices. A fundamental feature of the invention is that the typical wire wound electromagnetic coil is eliminated, and replaced functionally by printed coil structures that are embedded in multilayer circuit boards. The most significant advantages of the invention are the elimination of a great amount of mass (the mass of the wire winding), and the provision of coil connections that are integral to the printed circuit and therefore much more robust than prior art solenoid actuator construction.

PCBs can be manufactured with up to thirty layers of copper in a wide range of copper/insulator thicknesses. As is described in the prior art, a copper-trace spiral may be printed on each layer, resulting in very thin, lightweight coils. It is relatively easy to generate complex patterns on each layer to optimize the resultant magnetic field (shape and strength), and internal thermal planes can also be included to optimize heat rejection. A PCB bearing a large plurality of layers in surprisingly thin, a flat board in the range of 0.1 inch, with a mass that is a small fraction of the mass of wire in a comparable wirewound electromagnet.

In one aspect the invention comprises an electromagnetic coil formed of multiple printed conductor segments on multiple lamina of a multilayer PCB. The conductor segments are loops or spirals that are all disposed about a common axis and interconnected to form an embedded electromagnet in which the field contributions of each conductor segment are oriented for mutual reinforcement. A shaft extends through an opening formed coaxially in the PCB, and a permanent magnet with axially opposed poles is secured to the shaft in proximity to the PCB. Applying current to the embedded electromagnet generates a magnetic field that may attract or repel the permanent magnet, depending on the direction of the current and the resulting magnetic field. The permanent magnet thus drives the shaft axially to do useful work. A spring may be secured to one of the embedded PCB coils and connected to the shaft so that the shaft is resiliently biased axially with respect to the PCB, thus to establish a normal quiescent state.

In another aspect the invention comprises a pair of embedded PCB coils described above and assembled in parallel, spaced apart, coaxial relationship. A shaft extends through the central openings of each embedded coil, and the permanent magnet is disposed intermediate the two embedded PCB coils. The coils may be driven so that one repels the permanent magnet while the other attracts it, whereby the shaft may be driven reversibly to do useful work. The assembly may be augmented with a ferromagnetic detent component secured to one or both of the pair of embedded PCB coils. When no current is applied to the coils, the permanent magnet will be attracted preferentially to the nearest ferromagnetic detent component, thereby moving to a defined position adjacent the PCB coil. Powering the coils repels the permanent magnet away from the ferromagnetic detent component and attracts it toward the opposed end of the assembly. If both ends are provided with ferromagnetic detent components, the shaft will be magnetically latched at each end of its reversible axial motion in bistable fashion; if only one end has the detent, the shaft will return toward that one end whenever the coils are deactivated, in monostable motion. The ferromagnetic detent may comprise a strip or washer containing nickel, iron, steel, or the like.

The method and apparatus are suitable for devices of a size that is generally termed “micro”; that is, a dimension range of approximately 5-20 mm, though these figures are not necessarily size limitations. The micro-actuators described herein may be used to drive fluid pumping devices, fluid valves, electrical relay contacts, latch mechanisms, and the like.

In any of the aspects described above, the invention may include measures to guide the flux lines of the PM and the embedded electromagnets. The axially extending shaft is a key flux guide, and a metal or ferromagnetic frame or housing may extend between the PCBs that host the embedded electromagnetic coils. This increases the reluctance of the assembly and the efficiency of the device.

In a further aspect of the invention, a plurality of embedded electromagnetic coils may be arrayed in a common plane about a main axis transverse to the plane. A rotor is mounted on a shaft extending coaxially, and the rotor supports a plurality of PM having magnetic axes parallel to the main axis. The embedded coils are stationary, and are driven serially and sequentially to attract the PM in the rotor, so that the rotor is driven stepwise or continuously and useful work may be transferred through the shaft to a load.

In all of the embodiments and aspects of the invention, it is significant that most or all of the components may be assembled using established PCB fabrication processes and pick-and-place techniques that are easily accomplished in very high volume automated assembly lines. Thus these devices may be manufactured far more inexpensively than comparable prior art devices. Moreover, in comparison to existing solenoid actuators, the mass of wirewound coils is eliminated, and the fragile electrical connections of the fine wires of existing solenoids is replaced by fixed, robust connections of PCB construction.

### BRIEF DESCRIPTION OF THE DRAWING

FIGS. 1 and 2 are perspective views of the top and bottom surfaces, respectively, of a single layer of the multilayer PCB with embedded electromagnetic coils of the invention.

FIGS. 3 and 4 are plan views of the top and bottom surfaces, respectively, of a single layer of the multilayer PCB with embedded electromagnetic coils of the invention.

FIG. 5 is an exploded perspective view of a portion of the multilayer PCB with embedded electromagnetic coils of the invention.

FIG. 6 is a perspective view of one embodiment of a solenoid actuator using the multilayer PCB with embedded electromagnetic coils of the invention.

FIG. 7 is a plan view of the solenoid actuator depicted in FIG. 6.

FIGS. 8-10 are schematic views of the magnetic field lines of the embedded electromagnetic coils and the PM in different embodiments of a solenoid actuator.

FIG. 11 is a schematic view of a fluid pump device employing a solenoid actuator arrangement of the invention.

FIG. 12 is a schematic view of a fluid valve device employing a solenoid actuator arrangement of the invention.

FIG. 13 is an end view of the fluid valve device depicted in FIG. 12.

FIG. 14 is a bottom view of a brushless DC motor device employing the embedded PCB electromagnetic coils of the invention.

FIG. 15 is bottom view of a brushless DC motor device shown in FIG. 14.

FIG. 16 is a cross-sectional elevation of the brushless DC motor device shown in FIGS. 14 and 15.

FIG. 17 is a bottom view of a diaphragm pump or valve employing the embedded PCB electromagnetic coils of the invention.

FIGS. 18 and 19 are cross-sectional elevations of the diaphragm pump/valve of FIG. 17, showing it in the quiescent position and full stroke position, respectively.

### DETAILED DESCRIPTION OF THE INVENTION

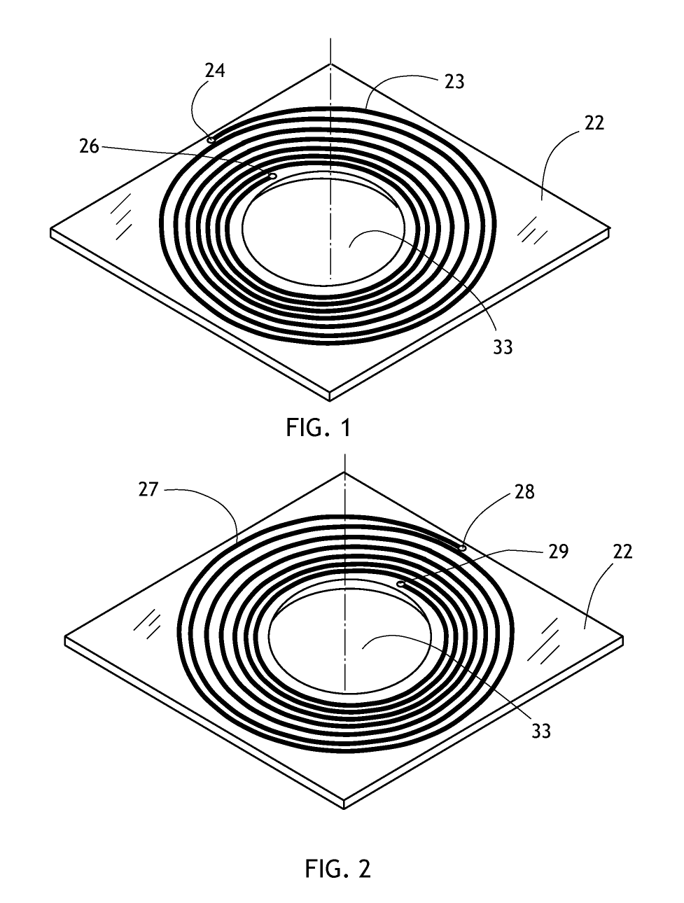

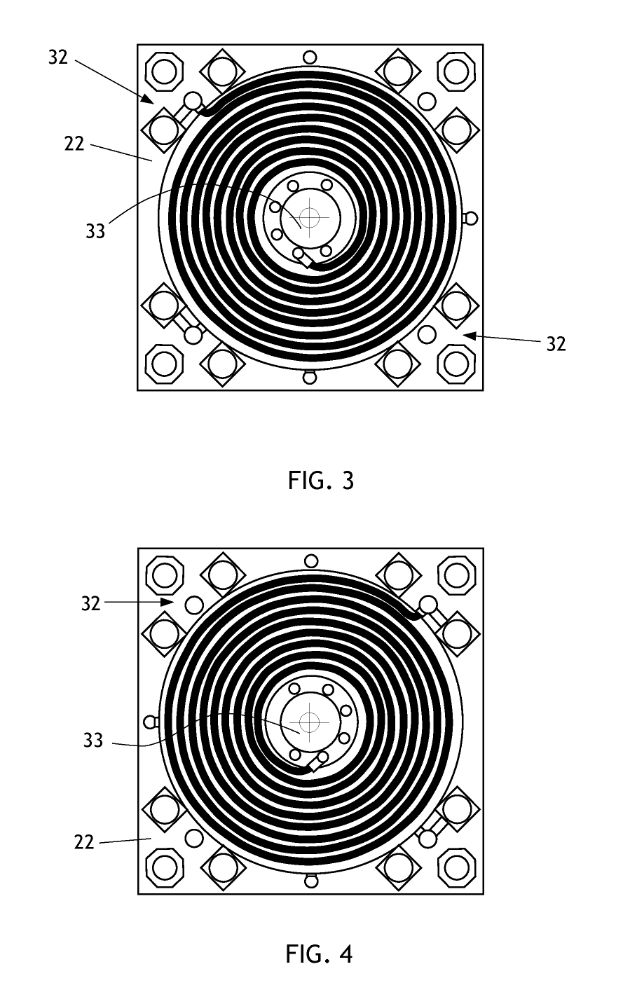

The present invention generally comprises a method and apparatus for construction of solenoid actuators and similar electromagnetic motor devices that employ printed coil structures that are embedded in multilayer circuit boards. With regard to FIGS. 1-6, a significant feature of the invention is the use of one or more embedded printed circuit electromagnetic coils 21 as a driver element for electromagnetic linear and rotary motors. Each embedded coil 21 is comprised of a plurality of individual lamina 22, each having a spiral conductor 23 printed on one surface and a spiral conductor 27 printed on the reverse side. A central opening 33 extends coaxially through the coil 21, and may be lined with a bushing (not shown). Conductor 23 terminates at its outer extent at contact pad/via 24 and at its inner extent at contact pad/via 26, while conductor 27 terminates at its outer extent at contact pad/via 28 and at its inner extent at contact pad/via 29. Each conductor may include as many as 10 or more concentric “turns” arranged in an Archimedean spiral in which the conductor curves in the plane of the lamina surface about a fixed central axis and increases smoothly in radial distance from the axis. These printed conductor formats of the preferred embodiment are not limiting factors for the invention in general.

The two spiral conductors are designed to proceed in opposite rotational directions, in the nature of left-hand and right-hand threads. The contact pad 24 of spiral conductor 23 is connected to a current source, and the inner contact pad/via 26 is connected to the inner contact pad/via of spiral conductor 27. The outer contact pad/via 28 is connected to the next adjacent lamina 22. Due to the fact that the coils 23 and 27 are reverse-handed, the magnetic fields created by the current flow through the two coils 23 and 27 are oriented in the same general direction and are additive, generating a strong local magnetic field that is polarized along the central axis.

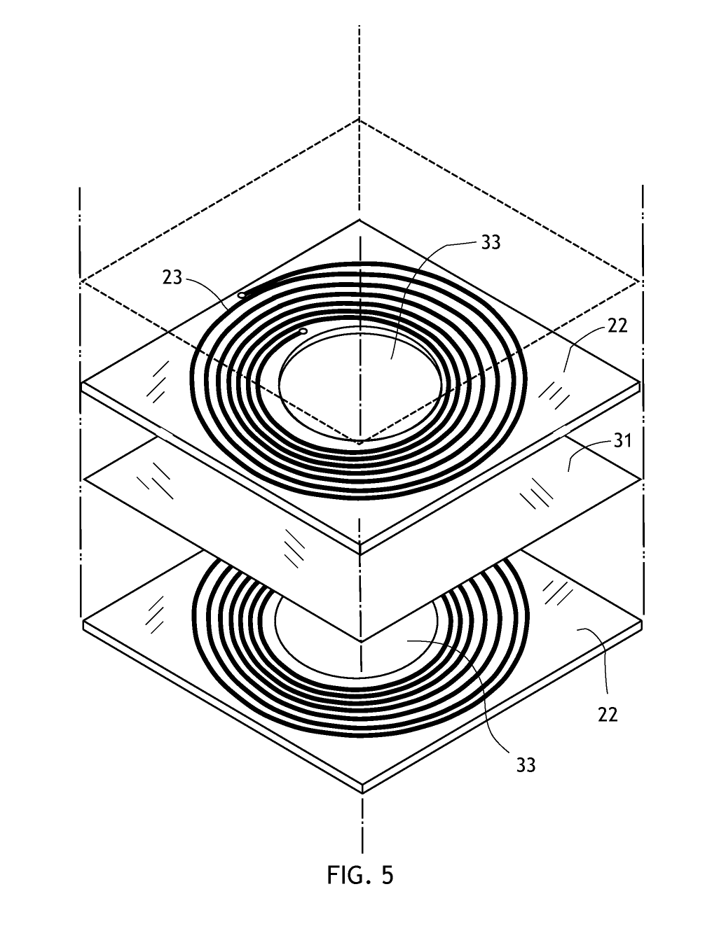

With regard to FIG. 5, the lamina 22 are stacked together in coaxial alignment, with an insulating binder layer 31 interposed between each two adjacent lamina 22. Vias 32 are provided so that the contact 28 of one lamina 22 may be connected to the contact 24 of the next adjacent lamina 22. The processes involved in printing the spiral conductors, forming the contact pads and vias, and laminating the layers together are all well-known in the printed circuit industry, and are reliable and inexpensive. PCB's having 20 or more layers are commonplace, and may be compressed into a multilayer board that is approximately 0.1 inch thick. As an example, providing twenty lamina 22, each having two printed coils with 10 turns each yields a combined coil of 400 turns in a very thin space, and the result is a surprisingly strong magnetic field. It appears that the current density (the radial and axial copper density or packing fractions) may be as important as the number of turns, and that there is an opportunity for significant optimization of embedded coils by modifying packing fractions within the laminated assembly.

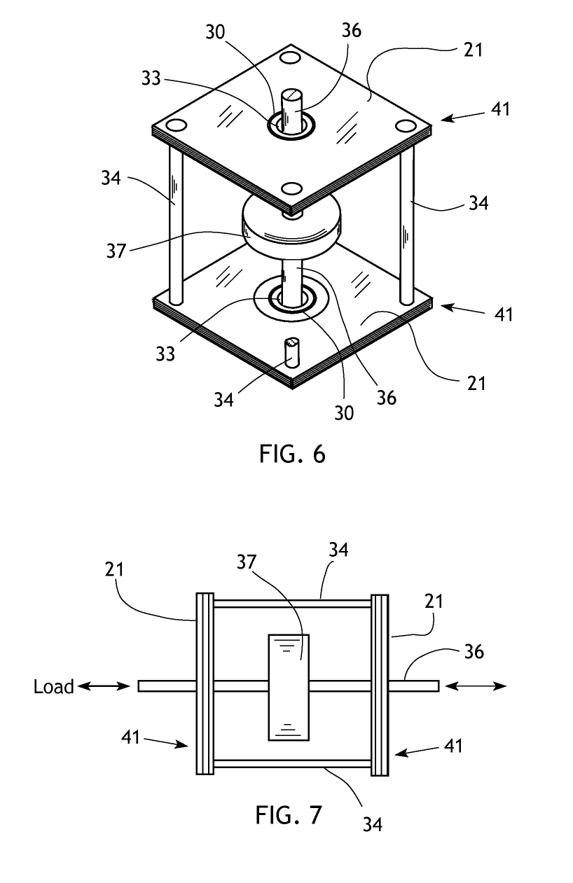

The embedded coils 21 described herein may be employed in a variety of magnetomotive applications. With reference to FIG. 6, a solenoid actuator may be formed by a pair of embedded coils 21 that are disposed parallel, spaced apart, and coaxial. In this embodiment the coils 21 are embedded in square plates 41 formed by cutting the coil 21 from a larger circuit board assembly. Other perimeter shapes such as rectangular, circular, hexagonal, and the like may be employed. A plurality of struts 34 are secured between the two plates 41 to maintain their spacing and rigid connection, the struts 34 having opposed ends that are secured adjacent respective vertices of the plates 41. A shaft 36 extends coaxially and is received through the central openings 33 of the plates 21, and a disk-like permanent magnet 37 is secured coaxially to a medial portion of the shaft 36. The magnet 37 is preferably a rare earth, high strength magnet, although other permanent magnets or ferromagnetic materials may suffice for some uses that require a less forceful device.

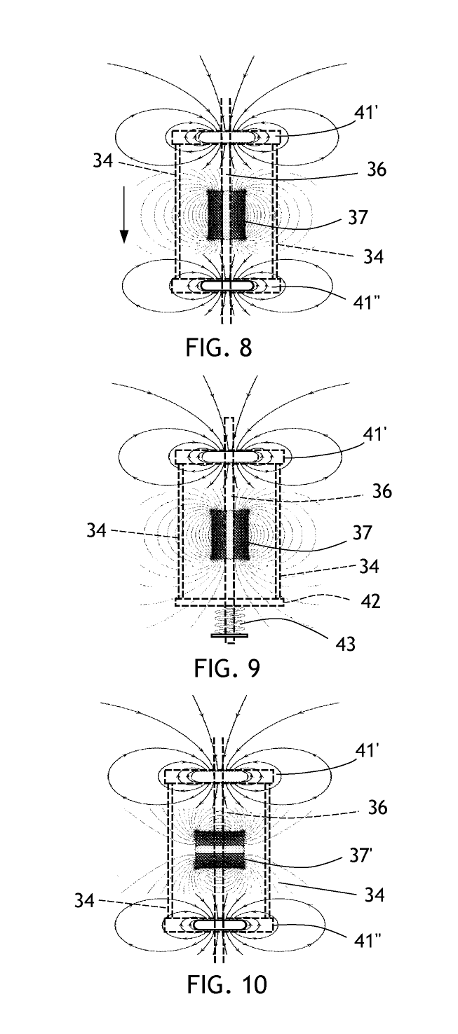

The opposite poles of magnet 36 are aligned coaxially with the shaft 36, and thus are in proximate relationship to respective plates 41 and their embedded coils 21. The shaft is an important part of the magnetic flux circuit of the device. Each of the coils 21 may be connected to a current source that is selectively directional, so that the each coil 21 may generate an electromagnetic field having opposite polarities that are aligned coaxially with the shaft 36 and the device in general. The polarity of the magnetic field may be reversed by reversing the current, a fundamental principle known in the prior art, to selectively generate magnetic poles that either repel or attract the adjacent poles of the permanent magnet 37. Thus, for example, as shown in FIG. 8, the coil of upper plate 41′ is driven to generate a magnetic field that repels the adjacent pole of permanent magnet 37, while the coil of lower plate 41″ is driven to generate a magnetic field that attracts its adjacent pole of magnet 37. As a result both magnetic fields drive the magnet 37 and shaft 36 linearly along the axis of the device, delivering a stroke of useful length and force. Clearly, the electromagnetic fields may be reversed to drive the shaft reversibly along the axis. The shaft motion may be cyclical, intermittent, sporadic, or continuous, depending on the electrical signals (AC, DC, pulsed) that drive the coils 21.

The solenoid actuator may additionally be provided with a ferromagnetic detent component secured to one or both of the pair of embedded PCB coils. For example, a washer or bushing 30 may be secured in the central opening 33 of one or both plates 41 and dimensioned to allow free translation of the shaft 36. When no current is applied to the coils, the permanent magnet 37 will be attracted preferentially to the nearest ferromagnetic detent component 30, thereby moving to a defined position adjacent the respective PCB coil. Powering the coils repels the permanent magnet 37 away from the ferromagnetic detent component and attracts it toward the opposed end of the assembly. If both ends are provided with ferromagnetic detent components, the shaft will be magnetically latched at each end of its reversible axial motion in bistable fashion; if only one end has the detent, the shaft will return toward that one end whenever the coils are deactivated, in monostable motion. This simple latching technique is achieved using very little added mass and no latch assembly.

For example, an exemplary device constructed as shown in FIGS. 6 and 7, having a total weight of about 5 grams, can produce a useful stroke of 0.25 inches at 8 oz. force. This compares to a solenoid actuator known in the prior art and having similar stroke and force outputs, which weighs on average 50 oz. This is a considerable advance over the prior art. Moreover, the fact that the device may be fabricated virtually entirely using established PCB fabrication methods and pick-and-place devices results in significant savings in production cost.

In an alternative embodiment shown in FIG. 9, the plate 41′ is connected by struts 34 to a plate 42 that does not include an embedded coil 21. A spring is mounted on the end of shaft 36 and supported to exert a restoring force in response to axial motion of the shaft 36. When the coil of upper plate 41′ is actuated, it will attract the permanent magnet 37, moving the shaft axially toward the plate 41′ and compressing spring 43. When the coil of upper plate 41′ is deactivated, the spring force restores the magnet 37 to a position spaced apart from the plate 41′. Thus the shaft 36 has an inherent quiescent position, the electromagnetic drive moves the shaft only when the coil 41′ is activate, and the shaft returns to the quiescent position after activation.

As noted above, the solenoid actuators described herein may be driven cyclically, intermittently, or continuously. When driven by a low frequency audio signal, the solenoid actuators vibrate perceptibly. They may be installed in a portable consumer product and used to provide haptic feedback to the user.

In a further embodiment of the solenoid actuator shown in FIG. 10, all the components are assembled as shown and described in FIG. 8. However, in this embodiment the magnet 37′ is polarized in diametrical opposition rather than axial opposition. When the coils of plates 41′ and 41″ are activated their magnetic fields interact with magnet 37 to cause it to rotate, thus driving the shaft 36 in a limited rotational excursion. Stops may be provided on the shaft 36 to prevent axial translation, if necessary.

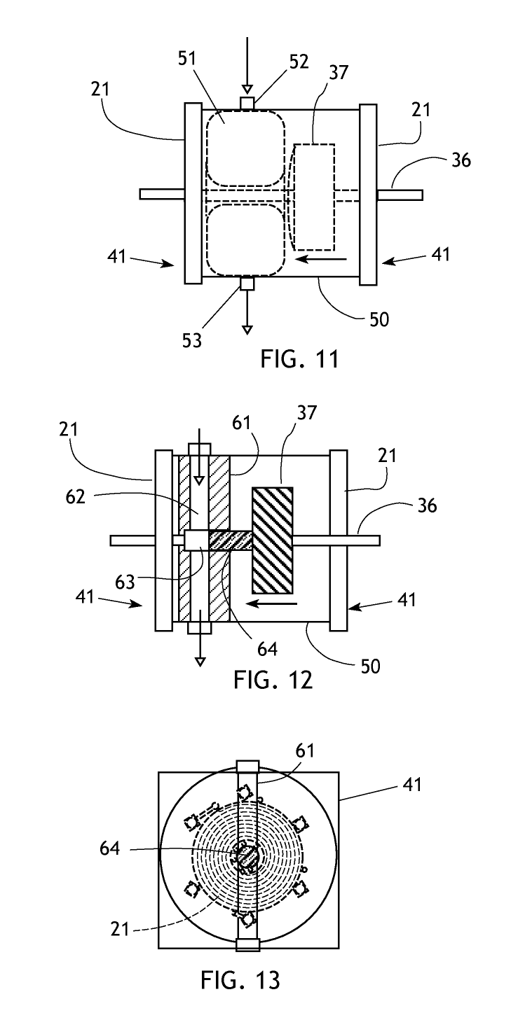

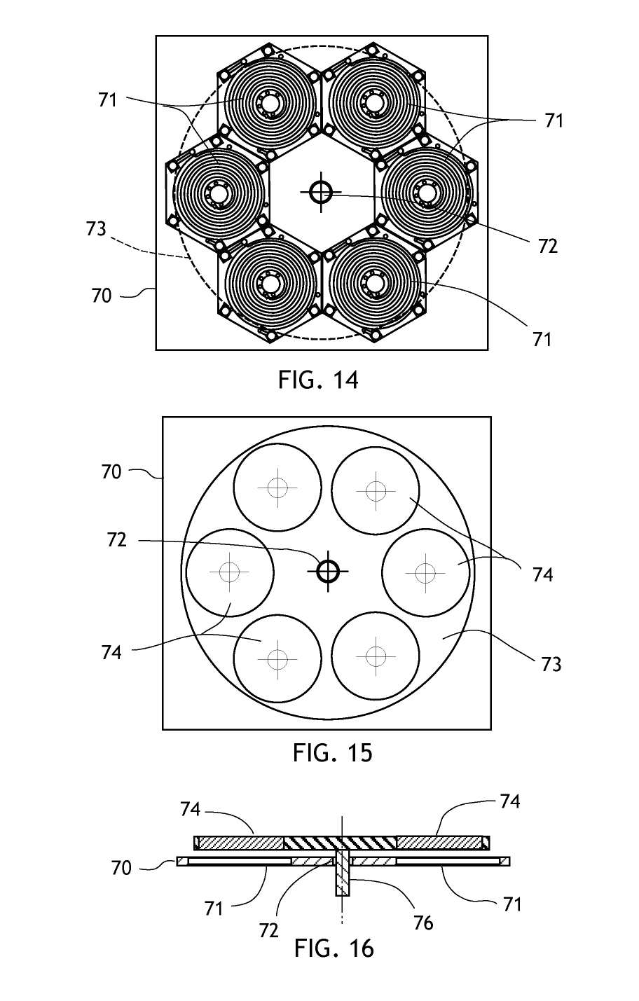

There are many possible applications of the embedded coil concept with a moving magnet to simple machines in a small format, and some of them are described below. With regard to FIG. 11, the solenoid actuator construction of FIGS. 6 and 7 may be employed as a simple pump. All of the components described in that solenoid actuator are employed, although the struts 34 may be replaced by a housing 50 that joins to the end plates 41 and encloses the device. In addition, a bladder 51 having a toroidal shape is interposed between the magnet 37 and one of the end plates 41, and the shaft 36 extends through the central opening of the toroidal bladder. The bladder 51 includes an inlet port 52 and outlet port 53, and appropriate check valves are provided but not shown. Whenever the device is actuated to drive the magnet 37 toward the bladder 51, the bladder is compressed and fluid is driven from the bladder; when the magnet 37 moves away from the bladder 51, the bladder refills due to its natural elasticity.

With regard to FIGS. 12 and 13, a simple valve may be constructed using the same basic solenoid actuator components described in FIGS. 6 and 7. A valve element 61 extend diametrically adjacent to one of the plates 41, and a flow channel 62 extends longitudinally through the valve element. In the center of the valve element 61, a valve seat 63 (here a cylindrical coaxial bore) extends through the valve element. A post 64 is secured coaxially to the magnet 37 adjacent to the valve element 61, and is dimensioned to be received in seat 63 in sealing fashion. A fluid source is connected to one end of the channel 62. When the device is actuated, the magnet is driven in the direction of the motion arrow, and the post 64 is translated into the seat 63 until it bottoms out, whereby the flow channel 62 is blocked. Reversing the movement of the magnet 37 opens the channel for fluid flow. As described previously, the use of a ferromagnetic latching component 30 may impart a normally closed or normally open characteristic to the valve.

With reference to FIGS. 15-17, a further embodiment for generating rotational motion comprises a brushless DC motor that employs the embedded coils of the invention. A plurality of embedded coils 71 are constructed similarly to embedded coils 21 described previously, and are arrayed at equal angles about a central opening 72. The coils 71 may be formed individually and assembled a shown (hence the hexagonal perimeter of the coils), or preferably may be formed together on the same PCB 70. A disk-like armature 73 is directly adjacent to the PCB 70, and includes an axially extending shaft 76 that extends through opening 72 in freely rotating fashion. The armature 73 includes a plurality of disk-like permanent magnets 74 arrayed at equal angles about the central axis of the assembly. The magnets 74 are polarized along axes parallel to the central axis of the assembly, and are thus oriented to interact with the magnetic field polarities of the coils 71. As is known in the prior art, the magnetic fields of the coils 71 may be switched sequentially and cyclically to attract the permanent magnets 74 in progressive angular fashion, causing the armature 73 to rotate. The switching of the polarity of the coils 71 is accomplished without brushes, slip-rings, or any other form of moving electrical contacts. A load may be coupled to the rotating shaft 76 to accomplish useful work.

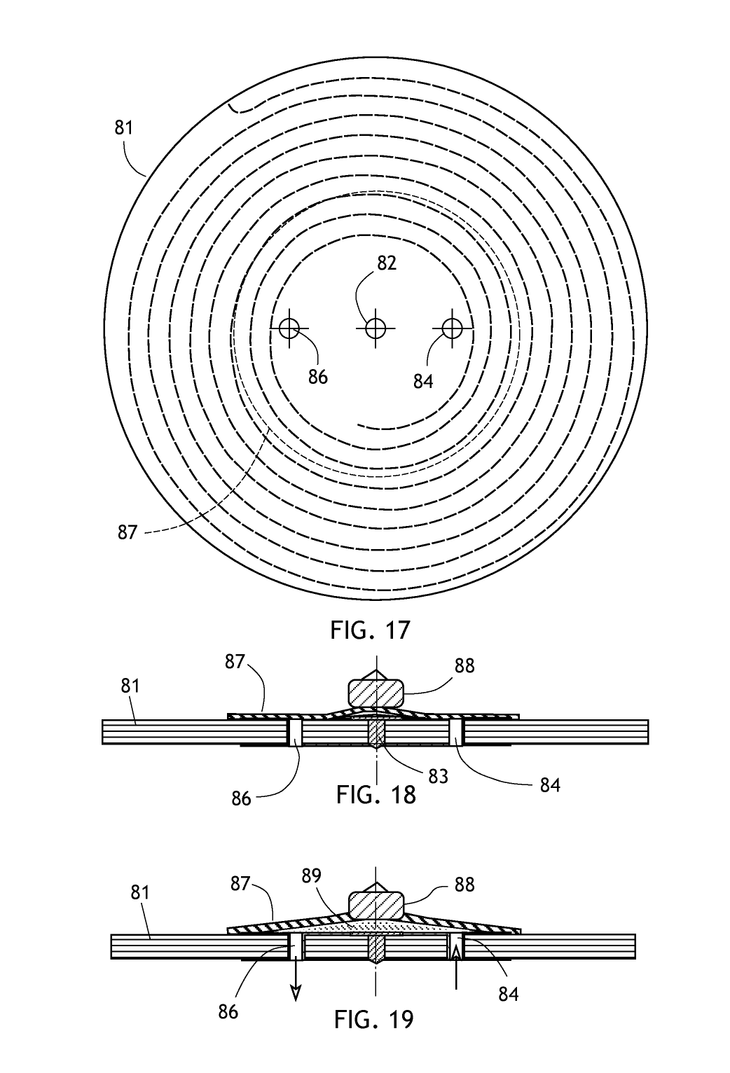

With regard to FIGS. 17-19, another embodiment of the invention employs an embedded coil 81 formed similarly to the coils 21 and 71 described previously. A central opening 82 extends axially through the coil 81, and a pin 83 formed of ferromagnetic material is secured in the opening 82. A pair of ports 84 and 86 also extend through the coil assembly 81 adjacent to the opening 82. A diaphragm 87 is secured at its perimeter to one surface of the coil 81, the diaphragm having a diameter sufficient to span and overlap the ports 84 and 86. Secured to a central portion of the diaphragm 87 is a permanent magnet 88 that is polarized along the axis of the assembly.

The ports 84 and 86 may be connected to a source of fluid and a fluid destination, respectively. The magnet 88 is attracted to the ferromagnetic pin 83 and pushes the center of the diaphragm 87 toward the upper surface of the embedded coil 81, creating a flush impingement of the diaphragm on the upper surface of the coil 81, as shown FIG. 18. As a result, there is no flow space between the diaphragm 87 and the upper surface of coil 81, and no opportunity for fluid to flow from port 84 to port 86. When the coil 81 is energized to repel the magnet 88, the magnet and diaphragm are driven away from the upper surface of the coil 81 (FIG. 19), and the diaphragm forms a flow space 89 between itself and the coil 81, thereby connecting the ports 84 and 86 for fluid flow therebetween. Thus the device of FIGS. 17-19 comprises a normally closed fluid valve.

The device of FIGS. 17-19 may be equipped with check valves connected to ports 84 and 86, in which case the coil 81 may be actuated to expand the diaphragm and draw fluid from inlet port 84 into the flow space 89. When the coil 81 is deactivated, the attraction of magnet 88 to pin 83 will collapse the diaphragm against the upper surface of the coil 81 and drive the fluid from flow space 89 through outlet port 86. Thus the device of FIGS. 17-19 may be configured as a fluid pump.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. An magnetomotive device, including:
a multi-layer PCB component having a first embedded electromagnetic coil comprised of a plurality of layers each having at least one printed conductor extending about a central axis that is transverse to the layers;
a movable ferromagnetic component;
at least one structural component for supporting said movable ferromagnetic component adjacent to said multi-layer PCB component in movable fashion, whereby energization of said coil generates an electromagnetic field that causes motion of said movable ferromagnetic component.

2. The magnetomotive device of claim 1, wherein said movable ferromagnetic component comprises a permanent magnet that is polarized along said central axis.

3. The magnetomotive device of claim 2, further including a shaft extending along said central axis, said permanent magnet secured concentrically about a medial portion of said shaft.

4. The magnetomotive device of claim 3, further including a first central opening extending axially through said first embedded electromagnetic coil, said shaft received through said first central opening in freely translatable fashion along said axis.

5. The magnetomotive device of claim 4, further including spring means secured to said at least one structural component and said shaft to resiliently bias said shaft in an axial direction.

6. The magnetomotive device of claim 4, further including a second embedded electromagnetic coil comprised of a plurality of layers each having at least one printed conductor extending about said central axis, said second coil supported by said at least one structural component and disposed parallel, spaced apart and coaxial to said first coil.

7. The magnetomotive device of claim 6, wherein said second coil includes a second central opening extending axially through said second embedded electromagnetic coil, said shaft received through said second central opening in freely translatable fashion along said axis.

8. The magnetomotive device of claim 7, wherein said permanent magnet translates reciprocally between said first and second embedded electromagnetic coils.

9. The magnetomotive device of claim 8, further including at least one fixed ferromagnetic component secured to at least one of said embedded electromagnetic coils, said permanent magnet being attracted to translate adjacent to said at least one fixed ferromagnetic component when neither of said coils are energized.

10. The magnetomotive device of claim 8, further including a pump bladder interposed between one of said first and second embedded coils and said permanent magnet and disposed to be compressed by translation of said permanent magnet toward said pump bladder and expanded by translation of said permanent magnet away from said pump bladder.

11. The magnetomotive device of claim 8, further including a fluid flow channel interposed between one of said first and second embedded coils and said permanent magnet and disposed to be selectively blocked or opened by translation of said shaft between said first and second embedded coils.

12. The magnetomotive device of claim 2, wherein said multi-layer PCB component has an first surface parallel to said layers, and said at least one structural component comprises a flexible diaphragm having a periphery secured to said first surface and concentric to said central axis.

13. The magnetomotive device of claim 12, further including a fluid chamber defined between said first surface of said multi-layer PCB component and a confronting surface of said flexible diaphragm, said fluid chamber expanding and contracting in accordance with axial movement of said permanent magnet by energization of said embedded electromagnetic coil.

14. The magnetomotive device of claim 13, further including at least one port extending to said fluid chamber to enable fluid flow into and out of said fluid chamber.

15. The magnetomotive device of claim 14, said at least one port comprising an inlet port and an outlet port extending through said multi-layer PCB component to said fluid chamber.

16. The magnetomotive device of claim 15, further including a fixed ferromagnetic component secured to said multi-layer PCB component and disposed at said central axis, said permanent magnet being attracted to translate toward said fixed ferromagnetic component and said first surface to establish a normally contracted fluid chamber.

17. The magnetomotive device of claim 2, wherein said at least one structural component includes a disk extending generally parallel to said multi-layer PCB component and having a rotational axis aligned with said central axis.

18. The magnetomotive device of claim 17, further including a plurality of said permanent magnets supported by said disk and distributed in angular spacing about said rotational axis.

19. The magnetomotive device of claim 18, further including a plurality of said embedded electromagnetic coils supported in said multi-layer PCB component and distributed in angular spacing about said central axis.

20. The magnetomotive device of claim 19, wherein said plurality of embedded electromagnetic coils may be energized reiteratively and sequentially to interact with said plurality of permanent magnets and rotate said disk about said rotational axis.
